(19) United States
(12) Patent Application Publication
(10) Pub. No.: US 2010/0075113 A1
(43) Pub. Date: Mar. 25, 2010

(54) PROCESS FOR PREPARING TRANSLUCENT PAPER OR FILM FOR USE WITH DIGITAL PRINTERS AND PRODUCT

(76) Inventors: Phil Schumacher, Menasha, WI (US); Bruce Peterson, New London, WI (US); John Kelly, Fond Du Lac, WI (US)

Correspondence Address: BOYLE FREDRICKSON S.C., 840 North Plankinton Avenue, MILWAUKEE, WI, 53203, US

(21) Appl. No.: 12/359,548

(22) Filed: Jan. 26, 2009

Related U.S. Application Data
(60) Provisional application No. 61/100,167, filed on Sep. 25, 2008.

(51) Int. Cl. G03G 5/00

(52) U.S. Cl. 428/195.1; 427/258

(57) ABSTRACT

A method and system for conditioning transparent or translucent paper or film for use with digital printers includes the application of a primer coat to the paper or film that controls the hygroscopic characteristics of the paper or film followed by the application of a digital primer that enables the reception of ink or toner during printing thereon by a digital printer. Opaque markers, such as opaque strips, may also be formed on the sheet of paper or film to facilitate detection of the transparent or translucent sheet by sensors, such as “electronic eye” of the digital printer.

### CROSS-REFERENCE TO RELATED APPLICATION

The present application claims the benefit of U.S. Ser. No. 61/100,167, titled “Translucent Paper for Digital Printing” and filed on Sep. 25, 2008, the disclosure of which is incorporated herein by reference.

### BACKGROUND OF THE INVENTION

The present invention relates generally to digital printing and, more particularly, to a process for preparing translucent or transparent paper and translucent or transparent films for use with a digital printer, and the product resulting from such a process.

Digital printing is increasingly becoming a widely used printing process. Many printers are seeking an ever-expanding source of specialty papers to use on digital printing presses. Most papers do not function with digital printing presses without adjustment to the physical properties of the paper. Specialty papers pose significant hurdles to their ability to process through digital printing equipment. In particular, conventional translucent paper or film can be particularly problematic due to its inherent physical qualities, not limited to and including the translucent properties of the paper or film itself. Transparent paper or film is similarly challenged.

Another drawback of translucent or transparent paper or film is that many printing machines have a sensor, e.g., electronic eye, which senses the leading edge or other marker of a sheet of paper or film when the paper or film is presented for printing. For non-translucent/non-transparent paper or film this is generally not problematic as the opacity of the paper or film itself serves as a detectable marker. Translucent and transparent paper or film however lack this opacity and thus are not easily detected by most electronic eyes.

One proposed solution is generally referred to as “tipping” and involves gluing a sheet of opaque paper or film to a sheet of translucent or transparent paper or film. The translucent or transparent paper or film may be detected by the printing press by virtue of the opaque sheet. After printing, the opaque sheet must be pulled from the printed-on paper or film and is usually discarded. So while effective in facilitating the detection of the transparent or translucent paper or film, tipping requires the adhesion of one sheet to another and the subsequent removal of the opaque sheet—all at a considerable cost and time.

Thus, there is a need for a translucent paper or film that can be effectively used with digital printing equipment, such as an HP Indigo 5000 or 5500 series digital press.

### BRIEF DESCRIPTION OF THE INVENTION

The present invention provides a translucent paper or film, which achieves high standard two-side print results when processed using a digital press, such as an HP Indigo 5000 or 5500 series digital press. The present invention provides a workable translucent printing paper, which exhibits both high quality print fidelity and low-curl lay flat properties otherwise known as dimensional stability.

In one representative example, the present invention is directed to a process for surface treating translucent paper or film to take on characteristics that allow the paper or film to be used with a digital press, such as an HP Indigo 5000 or HP Indigo 5500 series digital press. The process also treats the paper or film to be suitable for duplex printing (two-sides in one pass) as well as improving the anti-curl qualities of the paper.

In one embodiment, the paper or film is treated in a series of treatments that are applied using one pass through conventional coating equipment. In a first treatment application, a primer is applied to at least one surface of the translucent paper or film. In a second treatment application another surface treatment is added to the surface(s) of the sheet. Each surface treatment is preferably added in quantities of more than 0.5 g/m² and less than 5 g/m². On top of both treatment layers, an approximately ¼ inch opaque strip is printed in relation to the finished sheet size leading and trailing edge to provide an opaque section for optical triggers of the press equipment. In the next step of the treatment process heat is used to properly set the surface treatments to the surface of the translucent paper or film. Final sheet temperature in excess of 70° F. and less than 120° F. is preferred. Subsequent cooling to 68° F.±5° is also preferred. It is understood that in order to ensure proper treatment application and set, coating equipment speed is preferably between about 100 ft. per minute and 1500 ft. per minute.

In one embodiment of the invention, the first treatment is a primer coat applied to seal the sheet from moisture and humidity which advantageously reduces curling and adds stability to the sheet. In this regard, the first treatment largely eliminates the hygroscopic properties of the sheet. The second treatment is designed to prep the sheet for use with the press, i.e., to permit it to accept the ink or toner from the press.

It will be appreciated that in one preferred embodiment, both sides of the sheet are treated as described above. Further, in one preferred embodiment, opaque markers are formed at the leading and trailing edges of the sheet so that the sheet is detected during duplex printing.

It is understood that the present invention may be used to prepare paper for use with a number of types of presses, including but not limited to HP Indigo presses, NexPress presses, Xerox iGen presses, and most color copiers.

Therefore, in accordance with one aspect of the invention, a method of preparing translucent paper or film for use with a digital press includes presenting a first edge of the translucent paper or film to an ink source and then causing the ink source to deposit a marker of substantially opaque ink proximate the first edge of the translucent paper or film.

It is thus an object of the invention to provide translucent paper or film that can be detected by the electronic eye or other optical detector of a printer or press.

In accordance with another aspect, the invention is directed to a method of treating translucent paper or film for use with a digital press. The method includes applying a first surface treatment to the translucent paper or film that is designed to control hygroscopic characteristics of the translucent paper or film. The method further includes applying a second surface treatment to the translucent paper or film that is designed to condition the translucent paper or film to receive ink or toner from a digital printing press. The first and the second treatments are then cured.

It is thus another object of the invention to condition translucent paper or film for use with a digital printer.

According to another aspect of the invention, a printable sheet of translucent or transparent paper or film for use with a digital printing press designed to apply toner, such as dry toner or toner carried by a carrier oil, to the printable sheet is provided. The sheet includes a stock of translucent or transparent material, a primer coat on at least one side of the stock, and a toner acceptance coat on the primer coat.

It is thus a further object of the invention to provide translucent or transparent paper or film usable with a digital printer.

Other objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout.

In the drawings:

FIG. 1 is a top plan view of a sheet of transparent paper in accordance with the present invention;

FIG. 2 is a block diagram of a paper conditioning system according to the present invention;

FIG. 3 is a flow chart setting forth the steps of a paper conditioning process according to the present invention; and

FIG. 4 is a section view of the sheet of transparent paper shown in FIG. 1 taken along line 4-4 of FIG. 1.

### DETAILED DESCRIPTION

In one embodiment, the invention is directed to conditioning a sheet of translucent or transparent medium, such as paper or film, to be usable with a digital printer or printing machine, such as an HP Indigo 5000 or HP Indigo 5500 series digital press, but it is understood that the invention may be used to condition paper or film for use with other types of printers. Additionally, while the invention will be described more particularly with respect to conditioning a transparent sheet, it is understood that the invention may be used to condition translucent sheets. For purposes of this application, the terms “paper”, “sheet” and “film” shall be considered equivalent and will be interchangeably used throughout. Moreover, the use of one of the aforementioned medium types does not limit the invention to that one medium type.

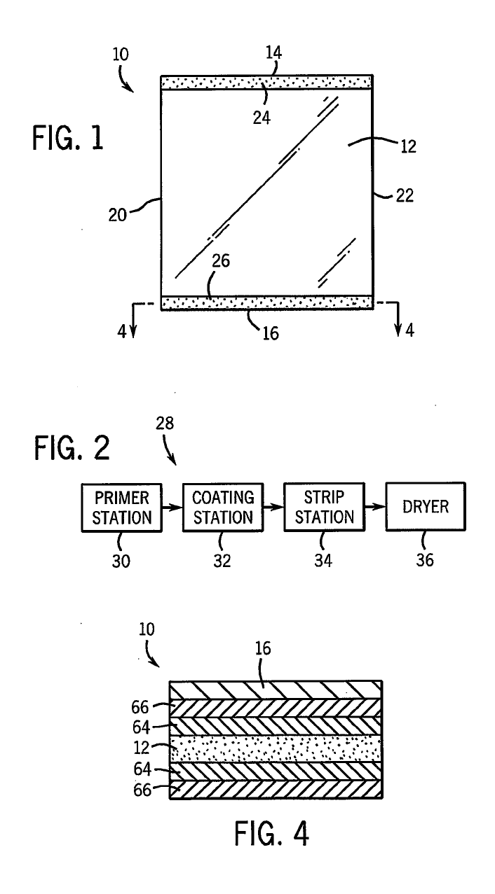

Referring now to FIG. 1, a sheet 10 according to one embodiment of the present invention includes a stock of transparent material 12, such as a stock of paper or film. The sheet 10 is defined by a leading edge 14, a trailing edge 16, and a pair of side edges 20, 22. In the illustrated example, the leading and trailing edges 14, 16 constitute the short edges of the sheet 10. Thus, for a 10×17 in. sheet, edges 14 and 16 are each 10 inches in length whereas edges 20, 22 are 17 inches in length. It is understood that the invention may be used to condition conventional paper sizes, e.g., 8.5 in.×11 in., 11 in.×17 in., 8.5 in.×14 in., etc., as well as custom sizes.

Many digital printing machines utilize an optical reader, e.g., “electronic eye”, or other electronic sensory or proximity device to detect the leading edge of the sheet. As known in the art, an optical reader detects the leading edge to generally control the printing process to provide consistent printing, paper jam detection, and the like. When printing paper or film with sufficient opacity, the optical reader will detect the leading edge of the paper or film itself. However, since transparent, or translucent paper or film, lacks this opacity, printing on transparent paper or film can be particularly problematic. As such, in one embodiment, the present invention provides a sheet 10 of transparent paper or film that has a pair of opaque markers 24 and 26. In one preferred embodiment, each opaque marker 24, 26 is in the form of an opaque strip formed adjacent to the leading and trailing edges 14, 16, respectively, of the paper or film 10. Preferably, each strip has a width of one-quarter inch and runs the entire length of its corresponding edge. In another preferred embodiment, only one opaque marker 24 or 26 is placed adjacent to the leading or trailing edge.

In a preferred embodiment, the opaque strips are white but it is contemplated that other colors may be used. In yet another embodiment, branding or other information is printed on the opaque strips. Notwithstanding the sheet 10 being transparent, the opaque markers 14, 16 will be detected by the printer's optical reader and thus perform as if the sheet was formed of opaque stock. It is preferred that the sheet 10 include an opaque marker adjacent to the leading edge and the trailing edge such that that trailing edge is detected as the leading edge during duplex printing. Moreover, having an opaque marker at each edge allows the paper or film to be loaded into the printer with either edge as the leading edge.

Referring now to FIG. 2, a flexographic printing system 28 for conditioning transparent paper or film to be used with a digital printing press generally includes a primer station 30, a coating station 32, a strip station 34, and a dryer 36. The paper or film is conveyed or otherwise transported to the stations in a conventional manner.

At the primer station 30, an aqueous primer coating is applied to the surfaces of the sheet. Alternately, a solvent-based primer could be applied to the surfaces of the sheet. The aqueous primer coating is designed to reduce moisture interactions between the sheet and the atmosphere. In this regard, the primer coat helps control the hygroscopic characteristics of the translucent sheet and thus reduce curling of the sheet. In a preferred embodiment, the primer coat is applied as a “flood coat” over the entire surface of the sheet to provide 100 percent coverage of the sheet surface. The amount of primer can be varied but preferably is more than approximately 0.5 g/m² and less than approximately 5 g/m². One type of primer is Michem Prime 4983R.

The coating station 32 applies, also preferably in a flood coat with 100 percent coverage, an aqueous digital primer to the sheet. The digital primer is designed to enable adhesion of a second primer coat of ink or toner, e.g., dry toner or toner in oil carrier, to the transparent sheet. One type of digital primer is DigiPrime 4431. Similar to the primer applied at the primer station 30, the digital primer is preferably applied at a quantity of more than approximately 0.5 g/m² and less than approximately 5 g/m².

After the second primer coat is applied, the transparent sheet is fed to strip station 34 that applies a pair of opaque strips to opposite edges of the transparent sheet. Preferably, opaque ink is applied as a strip at the leading and trailing edges of the transparent sheet. Preferably, the strips have a width of approximately one-quarter inch and extend along the entire length of the sheet edges. In one embodiment, white ink is used to form the strips but it is understood that other ink colors may be used. In a preferred embodiment, opaque strips are used as triggers for the optical reader of the printer but it is understood that other types of opaque markers may be used. Further, it is understood that the strips may be detected by various types of optical readers commonly used to detect the presence and position of an opaque sheet of paper.

After the strips have been applied, the transparent sheet is fed to a drying station 36 that heats and then cools the transparent sheet to cure the primers and the opaque strips. In a preferred embodiment, the sheet is heated to a temperature between 70° F. and 120° F. The sheet is then cooled to a temperature preferably of 68° F.±5°. The transparent sheet is preferably fed through the aforementioned stations at a rate between about 100 feet/minute and 1500 feet/minute.

In one embodiment, one side of the transparent sheet is conditioned in one pass of the aforedescribed stations and the opposite side of the transparent sheet is conditioned in another pass through the stations. It has been found that a single pass is sufficient to form the opaque markers and thus in a second pass the strip station 34 may be bypassed. However, it is contemplated that opaque strips or other markers may be formed on both sides of the transparent sheet.

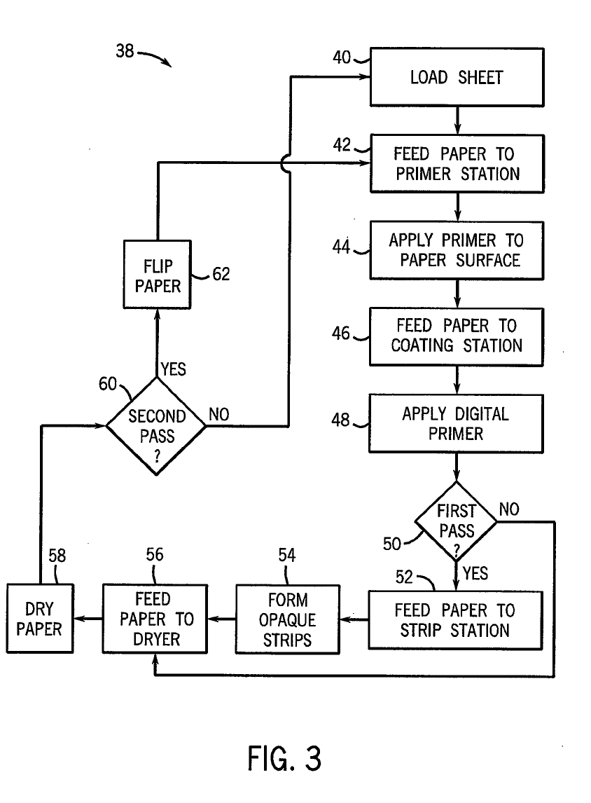

Referring now to FIG. 3, the steps of a conditioning process 38, carried out by the system 28 shown in FIG. 2, are set forth. The conditioning process 38 begins at block 40 with the loading of a transparent sheet and the presentation of the loaded sheet to the primer station 30 at block 42. The transparent sheet is loaded in a known manner. The first primer coat, which is designed to improve the hygroscopic characteristics of the sheet, is applied at block 44. The sheet, having a primed surface, is then fed to the coating station 32 at block 46 whereupon the digital primer, which is designed to enable the receptivity of ink or toner, is applied at block 48. If the sheet is in a first pass through the conditioning stations, as determined at block 50, the transparent sheet is fed to the strip station 50 at block 52, whereupon the opaque strips, or other markers, are formed on the primed surface of the transparent sheet at block 54. The primed sheet with the strips formed thereon is then fed to the dryer at block 56 whereupon the sheet is dried at block 58.

As described above, the conditioning system 28, FIG. 2, is designed to condition a sheet of transparent paper or film in two passes. Thus, at block 60 a determination is made as to whether the other side of the sheet needs to be conditioned. If so, the sheet is flipped at block 62 using suitable handling machinery and the sheet is then fed again to the primer station at block 42. If both sides of the sheet have been conditioned, the processing for that sheet is complete and the process returns to block 40, as needed, to condition another sheet.

As noted above, in accordance with one embodiment, opaque markers are formed only in one of the passes. Preferably, the opaque markers are formed in the first pass but it is contemplated that the opaque markers could be formed in the second pass. Alternately, one opaque marker could be formed on one side of the sheet and the other marker could be formed on the other side of the sheet and, as such, an opaque marker would be formed during both passes.

It is contemplated that the cured sheet could also be fed to a printer (not shown) that prints branding and/or other information on the opaque markers. Additionally, while in one embodiment multiple passes are used to condition the transparent sheet, it is contemplated that a sheet of paper or film may be fully conditioned in a single pass. It is also contemplated that any of a number of known techniques and associated machinery may be used to apply the aforedescribed primers and opaque markers.

As shown in FIG. 4, the transparent sheet 10 once conditioned has a base stock 12 sandwiched between a pair of primer coat layers 64. Each primer coat layer 64 is sandwiched between the stock 12 and a respective digital primer layer 66. An opaque marker 16 is formed on one of the primer layers 66.

As described herein, the digital primer enables the paper to effectively receive toner or ink from a digital printing press. It will be appreciated that the primer allows the paper to receive ink, dry toner, as well as toner contained in carrier oil.

Many changes and modifications could be made to the invention without departing from the spirit thereof. The scope of these changes will become apparent from the appended claims.

I claim:

1. A method of preparing a non-opaque sheet of material to be used with a digital press, comprising:
creating a substantially opaque marker proximate the first edge of a sheet of the non-opaque material such that when the sheet is fed through a printing machine that detects sheets with a sensor the sheet will be detected by virtue of the substantially opaque marker.

2. The method of claim 1, further comprising presenting the first edge of the non-opaque material to an ink source and causing the ink source to deposit ink on said sheet sufficient to create said substantially opaque marker.

3. The method of claim 2 further comprising presenting a second edge of the non-opaque sheet to the ink source and causing the ink source to deposit another marker of substantially opaque ink proximate the second edge of the non-opaque material such that when the non-opaque material is fed through the printing machine the second edge of the sheet will be detected during duplex printing of the non-opaque material.

4. The method of claim 3 wherein the second edge is generally opposite the first edge, and further comprising controlling the ink source such that the first mentioned marker is generally a quarter inch in width and extends along an entire length of the first edge and further controlling the ink source such that the second mentioned maker is generally a quarter inch in width and extends along an entire length of the second edge.

5. The method of claim 3 wherein the sheet of non-opaque material has a width and a length longer than the width, and therein the first edge and the second edge are defined along the width of the sheet.

6. The method of claim 2 further comprising applying at least one surface treatment to the sheet non-opaque material before presenting the sheet of non-opaque material to the ink source.

7. The method of claim 6 wherein applying the at least one surface treatment includes:
applying a curl control treatment to a first surface of the sheet of non-opaque material;
applying a digital coating to the first surface of the sheet of non-opaque material that conditions the first surface to accept ink or toner; and then
curing the curl control treatment, the digital coating, and the opaque markers.

8. The method of claim 7 wherein the curl control treatment includes a primer coat that is applied to the first surface of the sheet of non-opaque material.

9. The method of claim 8 wherein the primer coat and the digital coating are applied in respective flood coats.

10. The method of claim 7 wherein the application of the curl control treatment and the digital coating are repeated for a second surface, opposite the first surface, of the sheet of non-opaque material.

11. The method of claim 10 wherein the marker is formed on the sheet of non-opaque material before the curl treatment and the digital coating are applied to the second surface.

12. The method of claim 1 wherein the sheet of non-opaque material is transparent and the toner includes dry toner or toner contained in carrier fluid.

13. A method of treating a non-opaque sheet of paper or film to be used with a digital press, comprising:
applying a first surface treatment to the non-opaque paper or film that is designed to control hygroscopic characteristics of the non-opaque paper or film;
applying a second surface treatment to the non-opaque paper or film that is designed to condition the non-opaque paper or film to receive ink toner from a digital printing press; and
curing the first and the second surface treatments.

14. The method of claim 13 further comprising forming an optical trigger on the non-opaque paper or film.

15. The method of claim 14 wherein the optical trigger includes an opaque strip formed along a portion of the perimeter of the non-opaque paper or film.

16. The method of claim 15 further comprising printing indicia on the opaque strip, wherein the indicia includes identification information.

17. The method of claim 13 wherein curing includes heating the translucent paper or film and then cooling the non-opaque paper or film.

18. The method of claim 13 wherein the first surface treatment is a primer coat which seals the paper or film from moisture and humidity.

19. The method of claim 18 wherein the second surface treatment permits the paper or film to accept toner from a digital printing press.

20. The method of claim 13 wherein the non-opaque paper or film is transparent and the toner includes dry toner or toner contained in a carrier fluid.

21. A printable sheet of non-opaque paper or film for use with a digital printing press designed to apply ink toner to the printable sheet, comprising:
a stock of non-opaque material;
a primer coat on at least one side of the stock; and
a toner acceptance coat on the primer coat.

22. The sheet of claim 21 further comprising at least one electronic eye detectable marker formed adjacent at least one edge of the stock.

23. The sheet of claim 22 wherein the detectable marker is an opaque strip formed adjacent a leading edge of the stock.

24. The sheet of claim 23 further comprising branding on the opaque strip.

25. The sheet of claim 23 wherein the opaque strip is approximately one-quarter inch in width and extends entirely adjacent a short edge of the stock.
